(19) United States
(12) Patent Application Publication
(10) Pub. No.: US 2025/0233247 A1
(43) Pub. Date: Jul. 17, 2025

(54) POWER STORAGE DEVICE, LOWER CASE, AND METHOD OF MANUFACTURING LOWER CASE

(71) Applicant: TOYOTA JIDOSHA KABUSHIKI KAISHA, Toyota-shi (JP)

(72) Inventor: Tadaaki SHIMOHIGASHI, Fukuyama-shi (JP)

(73) Assignee: TOYOTA JIDOSHA KABUSHIKI KAISHA, Toyota-shi (JP)

(21) Appl. No.: 18/945,779

(22) Filed: Nov. 13, 2024

(30) Foreign Application Priority Data
Jan. 11, 2024 (JP) 2024-002529

(51) Int. Cl. H01M 50/242; H01M 50/204; H01M 50/271; H01M 50/289

(52) U.S. Cl. CPC H01M 50/242; H01M 50/204; H01M 50/271; H01M 50/289

(57) ABSTRACT

A power storage device includes a plurality of power storage cells and a housing. The housing includes a lower case and an upper cover. The lower case includes a bottom wall, a peripheral wall inclined gradually outward with an increasing distance from the bottom wall, a bottom rib, and a side rib. The peripheral wall includes a pair of side walls facing each other. The bottom rib is shaped to extend in an opposite direction in which the pair of side walls face each other. The side rib extends along a portion of each side wall, the portion intersecting a plane including the bottom rib. The side rib includes an outer surface shaped to extend gradually outward in the opposite direction toward the bottom wall.

### CROSS REFERENCE TO RELATED APPLICATIONS

This nonprovisional application is based on Japanese Patent Application No. 2024-002529 filed on Jan. 11, 2024, with the Japan Patent Office, the entire contents of which are hereby incorporated by reference.

### BACKGROUND

### Field

The present disclosure relates to a power storage device, a lower case, and a method of manufacturing a lower case.

### Description of the Background Art

Japanese Patent Laying-Open No. 2015-210895 discloses an assembled battery module including a plurality of secondary batteries, an aluminum die-cast housing that accommodates the plurality of secondary batteries, and a lid body covering an opening of the housing.

### SUMMARY

When the housing is manufactured by aluminum die casting, as in the assembled battery module described in Japanese Patent Laying-Open No. 2015-210895, the side walls of the housing are designed in a shape that is inclined to be gradually open outward from the bottom wall in an upward direction, in consideration of ease of releasing a die. This leads to a fear that when a load is applied to the battery module from the side, the bottom wall may be damaged due to the moment generated by the load, because the portion to which the load is applied is the upper end of the housing.

An object of the present disclosure is to provide a power storage device, a lower case, and a method of manufacturing a lower case that can simultaneously achieve efficient manufacture of a lower case and suppression of damage to a bottom wall upon application of a load to a side wall.

A power storage device according to an aspect of the present disclosure includes: a plurality of power storage cells; and a housing that accommodates the plurality of power storage cells. The housing includes a lower case that is open upward, and an upper cover covering the plurality of power storage cells. The lower case includes: a bottom wall; a peripheral wall rising from the bottom wall, the peripheral wall inclined gradually outward with an increasing distance from the bottom wall; a bottom rib provided on the bottom wall; and a side rib provided on the peripheral wall. The peripheral wall includes a pair of side walls facing each other. The bottom rib is shaped to extend in an opposite direction in which the pair of side walls face each other. The side rib extends along a portion of each of the pair of side walls, the portion intersecting a plane including the bottom rib. The side rib includes an outer surface shaped to extend gradually outward in the opposite direction toward the bottom wall.

A lower case according to an aspect of the present disclosure is a lower case that accommodates at least a lower portion of each of a plurality of power storage cells and is open upward. The lower case includes: a bottom wall; a peripheral wall rising from the bottom wall, the peripheral wall inclined gradually outward with an increasing distance from the bottom wall; a bottom rib provided on the bottom wall; and a side rib provided on the peripheral wall. The peripheral wall includes a pair of side walls facing each other. The bottom rib is shaped to extend in an opposite direction in which the pair of side walls face each other. The side rib extends along a portion of each of the pair of side walls, the portion intersecting a plane including the bottom rib. The side rib includes an outer surface shaped to extend gradually outward in the opposite direction toward the bottom wall.

A method of manufacturing a lower case according to an aspect of the present disclosure is a method of manufacturing the lower case described above. The method includes: a preparation step of preparing a first die and a second die, the first die and the second die being capable of contacting and separating from each other and having a space corresponding to the lower case while being in contact with each other; and a supply step of supplying a material forming the lower case to the space between the first die and the second die. In the preparation step, a die having a side wall forming portion is prepared as the second die, the side wall forming portion forming a portion of each of the pair of side walls other than the side rib, and a die having a side rib forming portion is prepared as the first die, the side rib forming portion forming the side rib and configured to be in abutting-contact with the side wall forming portion, an inner surface of the side rib forming portion corresponding to the outer surface of the side rib.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view of a lower case of a power storage device in one embodiment of the present disclosure, as viewed from above.

FIG. 2 is a perspective view of the lower case as viewed from below.

FIG. 3 is a plan view of the lower case.

FIG. 4 is a bottom view of the lower case.

FIG. 5 is a sectional view taken along the line V-V in FIG. 4.

FIG. 6 is a sectional view taken along the line VI-VI in FIG. 4.

FIG. 7 is a sectional view taken along the line VII-VII in FIG. 4.

FIG. 8 is a sectional view taken along the line VIII-VIII in FIG. 4.

FIG. 9 is a schematic sectional view of dies for manufacturing the lower case.

FIG. 10 is a schematic sectional view of the dies for manufacturing the lower case.

FIG. 11 is a sectional view schematically showing a case where a load is applied to a side wall of a lower case in a comparative example.

FIG. 12 is a sectional view schematically showing a case where a load is applied to a side wall of a lower case in the present embodiment.

FIG. 13 is a perspective view of a modification of the lower case as viewed from above.

FIG. 14 is a perspective view of the modification of the lower case as viewed from below.

### DESCRIPTION OF THE PREFERRED EMBODIMENTS

Embodiments of the present disclosure will be described with reference to the drawings. In the drawings referenced below, the same or corresponding portions are denoted by the same reference numerals.

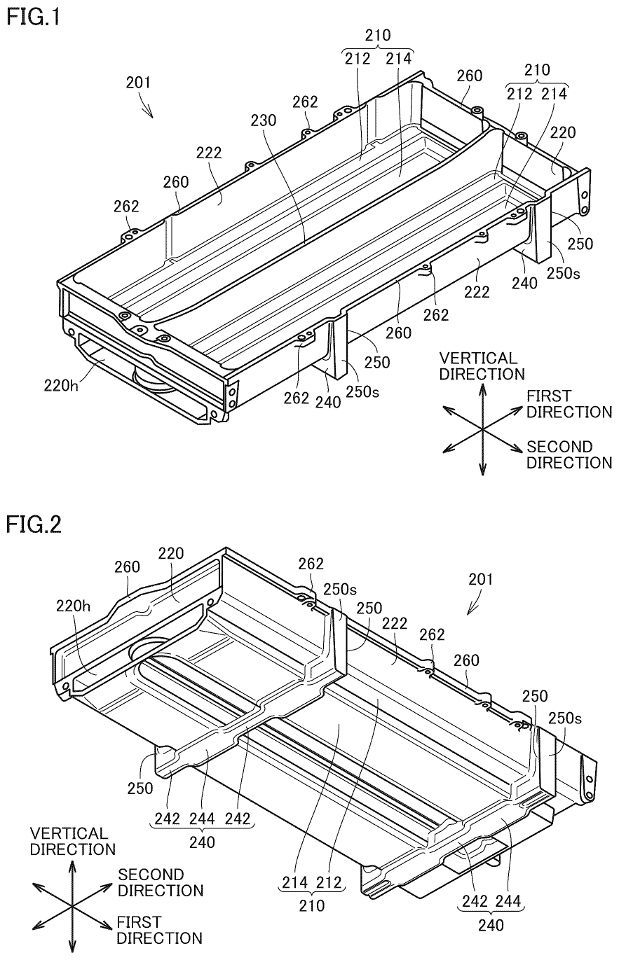

FIG. 1 is a schematic perspective view of a power storage device in one embodiment of the present disclosure. FIG. 2 is a plan view of the power storage device.

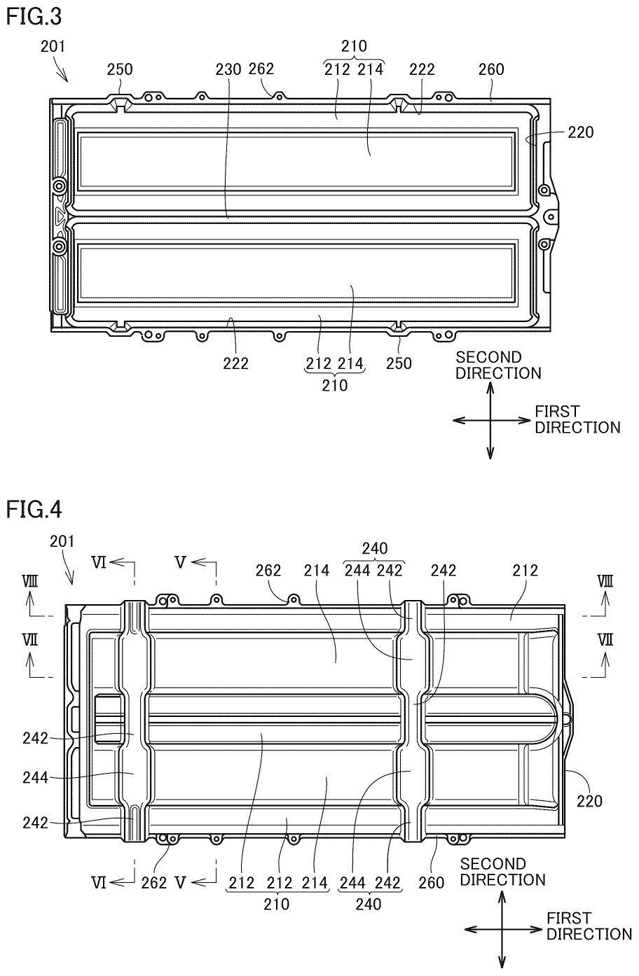

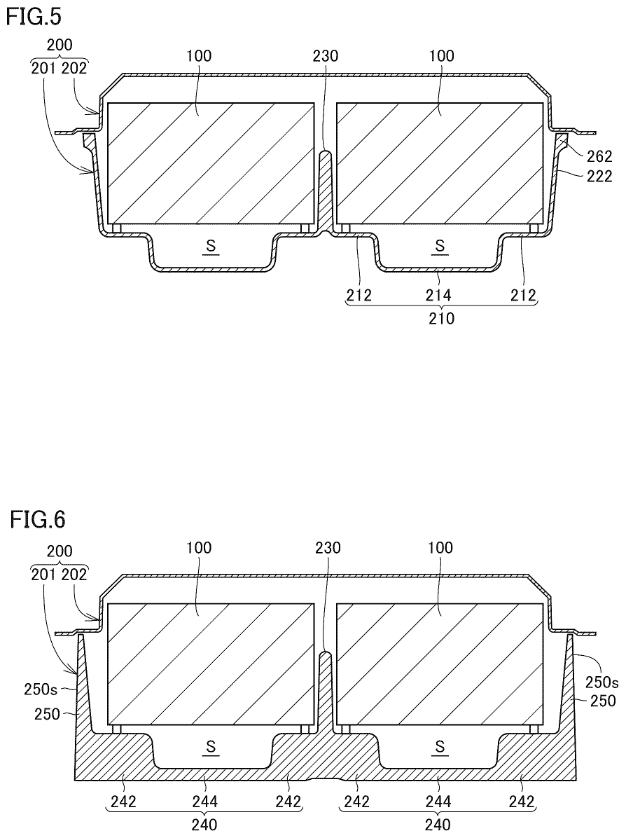

As shown in FIGS. 1 to 8, a power storage device 1 includes a plurality of power storage cells 100 (see FIGS. 5 and 6) and a housing 200.

Power storage cells 100 are arranged side by side along a first direction. Each power storage cell 100 is, for example, a lithium ion battery. Each power storage cell 100 may be formed of a so-called all-solid-state battery containing a solid electrolyte. Each power storage cell 100 is formed in an approximately rectangular parallelepiped shape.

Housing 200 accommodates power storage cells 100. Housing 200 includes a lower case 201 and an upper cover 202 (see FIGS. 5 and 6). Lower case 201 accommodates at least the lower portion of each power storage cell 100. Lower case 201 supports power storage cells 100. Lower case 201 is open upward. Lower case 201 is made of metal. In the present embodiment, lower case 201 is made of aluminum. Upper cover 202 covers power storage cells 100.

Lower case 201 will be described below in detail. Lower case 201 includes a bottom wall 210, a peripheral wall 220, a partition wall 230, a bottom rib 240, a side rib 250, a flange 260, and a thick portion 262.

Bottom wall 210 supports power storage cells 100. Bottom wall 210 includes a support surface 212 and a recess 214.

Support surface 212 supports power storage cells 100. In the present embodiment, bottom wall 210 includes a pair of support surfaces 212 supporting each power storage cell 100. The pair of support surfaces 212 are spaced apart from each other in a second direction orthogonal to both the first direction and the vertical direction. Support surface 212 is formed to be flat. Support surface 212 extends along the first direction.

Recess 214 is recessed downward from support surface 212. Recess 214 is formed between the pair of support surfaces 212 facing each other in the second direction. As shown in FIGS. 5 and 6, a space S is formed below each power storage cell 100. Recess 214 is formed to be flat. Recess 214 may be used as a cooling air duct for air-cooling each power storage cell 100 or as a smoke exhaust duct that forms an exhaust path for gas discharged from a safety valve located on the lower surface of power storage cell 100. Recess 214 may also be used as a space for arranging battery management devices such as battery management system (BMS) and electronic control unit (ECU), and electronic devices such as system main relay (SMR) and fuse.

Perimeter wall 220 rises from bottom wall 210. Perimeter wall 220 is inclined gradually outward with an increasing distance from bottom wall 210. One of a pair of wall portions of peripheral wall 220 facing each other in the first direction has an opening 220h that opens space S to the outside.

Peripheral wall 220 includes a pair of side walls 222 facing each other. The pair of side walls 222 face each other in the second direction. Each side wall 222 extends along the first direction, that is, the direction in which power storage cells 100 are arranged side by side.

Partition wall 230 partitions the space encircled by peripheral wall 220. In the present embodiment, partition wall 230 divides the space encircled by peripheral wall 220 into two parts. Partition wall 230 extends along the first direction. The ends of partition wall 230 in the first direction are connected to perimeter wall 220. Partition wall 230 rises from bottom wall 210. The lower end of partition wall 230 is connected to support surface 212.

Bottom rib 240 is provided on bottom wall 210. Bottom rib 240 is shaped to extend in the opposite direction (second direction) in which the pair of side walls 222 face each other. In the present embodiment, lower case 201 includes two bottom ribs 240 provided at positions spaced apart from each other in the first direction. Each bottom rib 240 includes a support surface overlap portion 242 and a recess overlap portion 244.

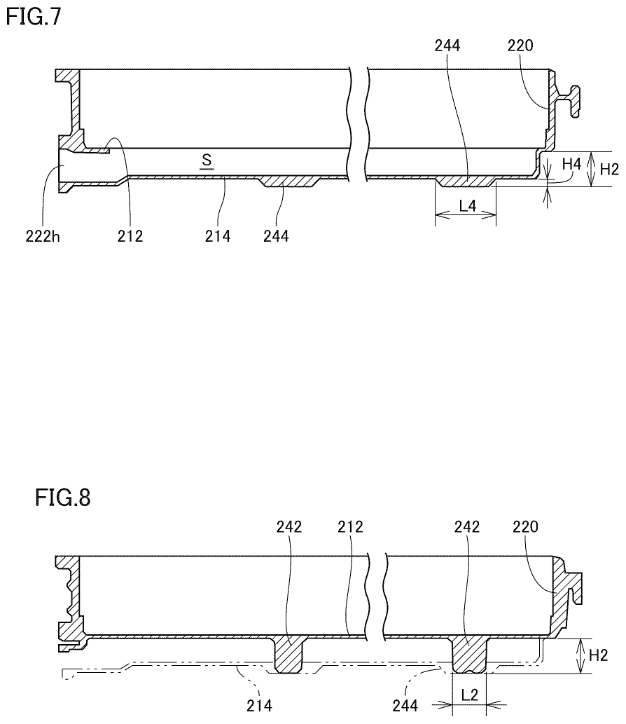

Support surface overlap portion 242 overlaps support surface 212 in the vertical direction. Recess overlap portion 244 overlaps recess 214 in the vertical direction. The lower surface of support surface overlap portion 242 is flush with the lower surface of recess overlap portion 244. As shown in FIGS. 7 and 8, a length H4 of recess overlap portion 244 in the vertical direction is smaller than a length H2 of support surface overlap portion 242 in the vertical direction. A length LA of recess overlap portion 244 in the orthogonal direction (first direction), which is orthogonal to both the vertical direction and the opposite direction, is greater than a length L2 of support surface overlap portion 242 in the orthogonal direction. The volume of support surface overlap portion 242 and the volume of recess overlap portion 244 may be set to be equal to each other. In FIG. 8, recess 214 and recess overlap portion 244 are indicated by the chain double-dashed line.

Side rib 250 is provided on peripheral wall 220. Specifically, side rib 250 extends along a portion of each side wall 222 which intersects a plane including bottom rib 240. Side rib 250 is connected to bottom rib 240. As shown in FIG. 1, the portion of side wall 222 which overlaps side rib 250 protrudes outward in the second direction.

Side rib 250 includes an outer surface 250s shaped to extend gradually outward in the opposite direction (second direction) toward bottom wall 210. In the present embodiment, outer surface 250s is formed to be flat. However, outer surface 250s may, for example, be curved so as to protrude outward or inward in the opposite direction or may be constituted of a plurality of flat surfaces intersecting each other, as long as it is shaped to extend gradually outward in the opposite direction toward bottom wall 210.

Side rib 250 is shaped to have a gradually increasing thickness (length in the second direction) toward bottom wall 210 because side wall 222 is inclined gradually outward in the second direction toward its top, and outer surface 250s of side rib 250 is inclined gradually outward in the second direction toward its bottom.

Flange 260 projects outward from the upper end of each side wall 222. In the present embodiment, flange 260 extends outward from the upper end of peripheral wall 220. In other words, flange 260 is annularly formed.

A thick portion 262 is provided on flange 260. Thick portion 262 has a thickness greater than the thickness of flange 260. Thick portion 262 receives a fastening member (not shown) that fastens upper cover 202 to lower case 201. Thick portion 262 is formed at a position distant from side rib 250 in the first direction. The outer end of thick portion 262 in the second direction may be located outside of the outer end of side rib 250 in the second direction.

Bottom wall 210, peripheral wall 220, bottom rib 240, and side rib 250 are made of the same material (aluminum in the present embodiment) and are contiguously connected to each other. More particularly, bottom wall 210, peripheral wall 220, partition wall 230, bottom rib 240, side rib 250, flange 260, and thick portion 262 are made of the same material and are contiguously connected to each other.

Next, a method of manufacturing lower case 201 will be described. Lower case 201 is manufactured by, for example, die casting. In other words, lower case 201 is a die-cast case. The method of manufacturing lower case 201 includes a preparation step and a supply step.

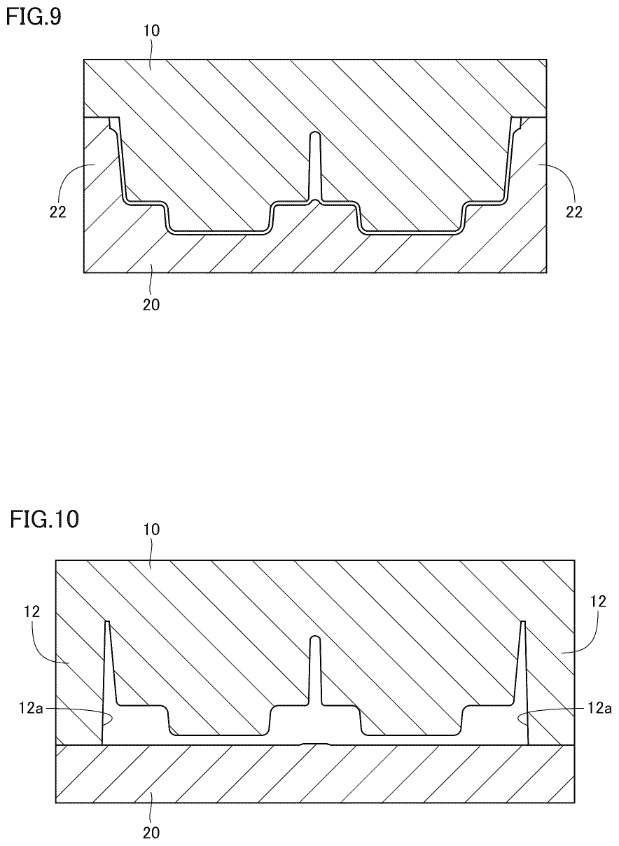

In the preparation step, a first die 10 and a second die 20 used for manufacturing lower case 201 are prepared. FIGS. 9 and 10 show first die 10 and second die 20. First die 10 and second die 20 can contact and separate from each other and have a space corresponding to lower case 201 while being in contact with each other. FIG. 9 shows cross-sections of first die 10 and second die 20 in a plane orthogonal to the first direction and passing through the portion forming thick portions 262. FIG. 10 shows cross-sections of first die 10 and second die 20 in a plane orthogonal to the first direction and passing through the portion forming side ribs 250.

As shown in FIG. 9, second die 20 includes a side wall forming portion 22 that forms a portion of each of the pair of side walls 222 other than side rib 250.

As shown in FIG. 10, first die 10 includes a side rib forming portion 12 forming side rib 250. An inner surface 12a of side rib forming portion 12 corresponds to outer surface 250s of side rib 250. Inner surface 12a is inclined gradually outward in the downward direction. Side rib forming portion 12 is configured to be “in abutting-contact” with side wall forming portion 22.

In the supply step, the material (aluminum in the present embodiment) forming lower case 201 is supplied to the space between first die 10 and second die 20. After the supply step, lower case 201 is formed by releasing first die 10 and second die 20.

As described above, in power storage device 1 in the present embodiment, peripheral wall 220 is inclined gradually outward with an increasing distance from bottom wall 210, and side rib 250 includes outer surface 250s shaped to extend gradually outward in the opposite direction (second direction) toward bottom wall 210, thus enabling efficient manufacture of lower case 201 by die casting.

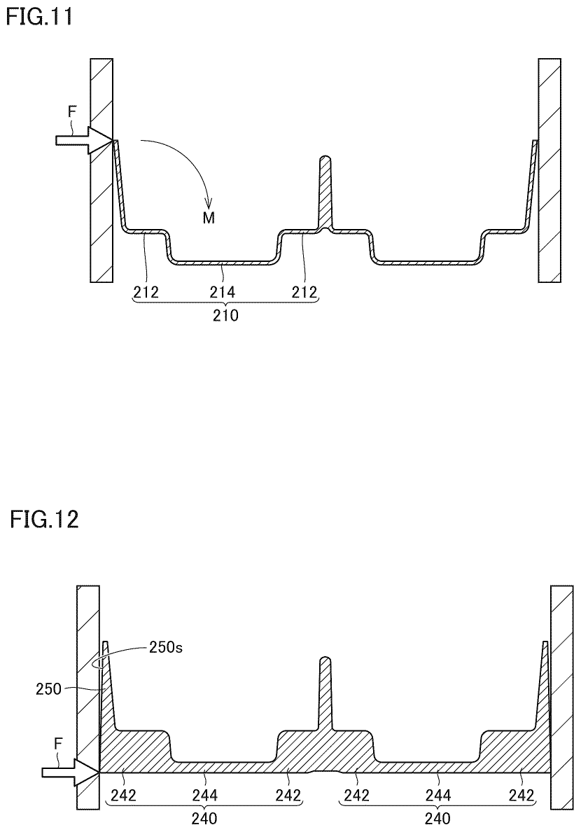

For example, as shown in FIG. 11, when a load F is applied to side wall 222 of lower case 201 without side rib 250, it is feared that bottom wall 210, especially recess 214, may be damaged due to a bending moment M generated by load F.

In the present embodiment, however, side rib 250 extends along the portion of each side wall 222 which intersects the plane including bottom rib 240, and outer surface 250s of side rib 250 is shaped to extend gradually outward in the opposite direction toward bottom wall 210. As shown in FIG. 12, thus, load F applied to side wall 222 is effectively received by the bottom end of side rib 250 and bottom rib 240. In other words, in the present embodiment, in the plane including bottom rib 240 and side rib 250, practically no moment is caused due to load F applied to side wall 222.

When the second direction is perpendicular to the first direction (the direction in which power storage cells 100 are arranged side by side), a load applied to power storage cells 100 in the second direction in which the allowable range of input load is relatively small can be reduced because bottom ribs 240 extend in the second direction.

In the present embodiment, thus, efficient manufacture of lower case 201 and suppression of damage to bottom wall 210 upon application of a load to side wall 222 are achieved simultaneously.

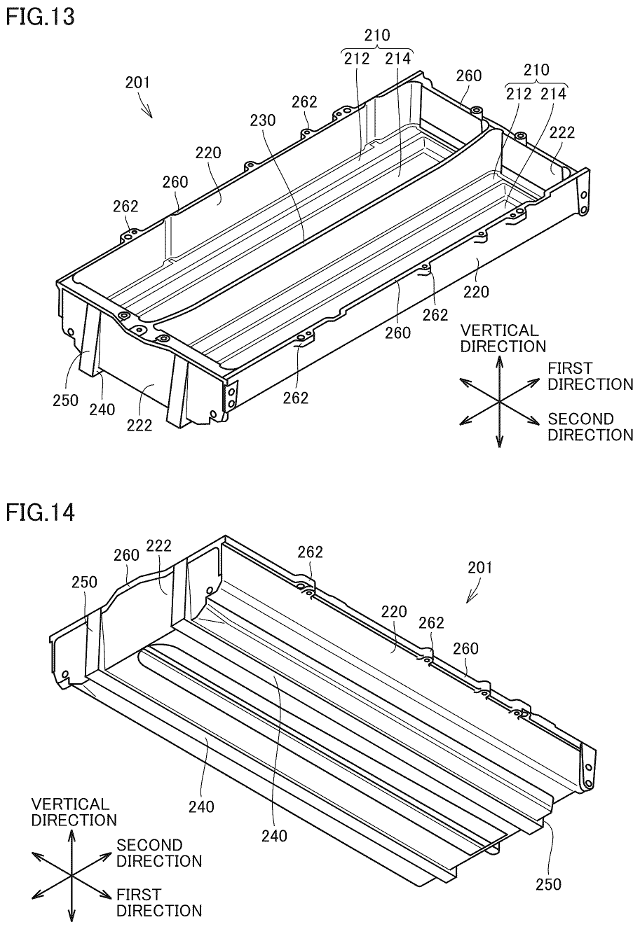

As shown in FIGS. 13 and 14, the pair of side walls 222 may face each other in the first direction (the direction in which power storage cells 100 are arranged side by side), and bottom rib 240 may extend along the first direction, that is, the longitudinal direction of peripheral wall 220.

It will be appreciated by a person skilled in the art that the exemplary embodiments and examples described above are specific examples of the following aspects.

### Aspect 1

A power storage device including:
a plurality of power storage cells; and
a housing that accommodates the plurality of power storage cells, wherein
the housing includes
   a lower case that is open upward, and
   an upper cover covering the plurality of power storage cells,
the lower case includes
   a bottom wall,
   a peripheral wall rising from the bottom wall, the peripheral wall inclined gradually outward with an increasing distance from the bottom wall,
   a bottom rib provided on the bottom wall, and
   a side rib provided on the peripheral wall,
the peripheral wall includes a pair of side walls facing each other,
the bottom rib is shaped to extend in an opposite direction in which the pair of side walls face each other,
the side rib extends along a portion of each of the pair of side walls, the portion intersecting a plane including the bottom rib, and
the side rib includes an outer surface shaped to extend gradually outward in the opposite direction toward the bottom wall.

In the power storage device, the lower case can be efficiently manufactured by die casting because the peripheral wall is inclined gradually outward with an increasing distance from the bottom wall and the side rib includes an outer surface shaped to extend gradually outward in the opposite direction toward the bottom wall. Further, the load applied to the side wall is effectively supported by the lower end of the side rib and the bottom rib because the side rib extends along the portion of each side wall which intersects the plane including the bottom rib. This simultaneously achieves efficient manufacture of the lower case and suppression of damage to the bottom wall upon application of a load to the side wall.

### Aspect 2

The power storage device according to aspect 1, wherein the lower case further includes
a flange projecting outward from an upper end of each of the pair of side walls, and
a thick portion provided on the flange and having a thickness greater than a thickness of the flange.

In this aspect, a load applied to the side wall due to vibration or the like is received by the thick portion, thus suppressing deformation of the side wall.

### Aspect 3

The power storage device according to aspect 2, wherein the thick portion is formed at a position distant from the side rib.

In this aspect, the load capacity of the lower case is improved because a load applied to the side wall is received more reliably by the lower end of the side rib and the bottom rib than when the thick portion is provided in the plane including the side rib.

### Aspect 4

The power storage device according to any one of aspects 1 to 3, wherein
the bottom wall includes
   a support surface supporting the plurality of power storage cells, and
   a recess recessed downward from the support surface,
the bottom rib includes
   a support surface overlap portion overlapping the support surface in a vertical direction, and
   a recess overlap portion overlapping the recess in the vertical direction, and
a length of the recess overlap portion in the vertical direction is smaller than a length of the support surface overlap portion in the vertical direction, and a length of the recess overlap portion in an orthogonal direction is greater than a length of the support surface overlap portion in the orthogonal direction, the orthogonal direction being orthogonal to both the vertical direction and the opposite direction.

In this aspect, the load capacity of the lower case is improved while an increase in the overall length of the lower case in the vertical direction is suppressed.

### Aspect 5

The power storage device according to aspect 4, wherein a lower surface of the support surface overlap portion is flush with a lower surface of the recess overlap portion.

In this aspect, suppression of an increase in the overall length of the lower case in the vertical direction and improvement in the load capacity of the lower case are achieved more reliably.

### Aspect 6

The power storage device according to any one of aspects 1 to 5, wherein the side rib is connected to the bottom rib.

### Aspect 7

The power storage device according to any one of aspects 1 to 6, wherein the bottom wall, the peripheral wall, the bottom rib, and the side rib are made of a same material and are contiguously connected to each other.

### Aspect 8

The power storage device according to any one of aspects 1 to 7, wherein the housing is a die-cast case.

### Aspect 9

A lower case that accommodates at least a lower portion of each of a plurality of power storage cells and is open upward, the lower case including:
a bottom wall;
a peripheral wall rising from the bottom wall, the peripheral wall inclined gradually outward with an increasing distance from the bottom wall;
a bottom rib provided on the bottom wall; and
a side rib provided on the peripheral wall, wherein
the peripheral wall includes a pair of side walls facing each other,
the bottom rib is shaped to extend in an opposite direction in which the pair of side walls face each other,
the side rib extends along a portion of each of the pair of side walls, the portion intersecting a plane including the bottom rib, and
the side rib includes an outer surface shaped to extend gradually outward in the opposite direction toward the bottom wall.

### Aspect 10

A method of manufacturing the lower case according to aspect 9, the method including:
a preparation step of preparing a first die and a second die, the first die and the second die being capable of contacting and separating from each other and having a space corresponding to the lower case while being in contact with each other; and
a supply step of supplying a material to the space between the first die and the second die, the material forming the lower case,
wherein in the preparation step,
   a die having a side wall forming portion is prepared as the second die, the side wall forming portion forming a portion of each of the pair of side walls other than the side rib, and
   a die having a side rib forming portion is prepared as the first die, the side rib forming portion forming the side rib and configured to be in abutting contact with the side wall forming portion, an inner surface of the side rib forming portion corresponding to the outer surface of the side rib.

Although the embodiments of the present disclosure have been described, it should be understood that the embodiments disclosed herein are illustrative and non-restrictive in every respect. The scope of the present disclosure is defined by the terms of the claims and is intended to include any modifications within the scope and meaning equivalent to the terms of the claims.

What is claimed is:

1. A power storage device comprising:
a plurality of power storage cells; and
a housing that accommodates the plurality of power storage cells, wherein
the housing includes
a lower case that is open upward, and
an upper cover covering the plurality of power storage cells,
the lower case includes
a bottom wall,
a peripheral wall rising from the bottom wall, the peripheral wall inclined gradually outward with an increasing distance from the bottom wall,
a bottom rib provided on the bottom wall, and
a side rib provided on the peripheral wall,
the peripheral wall includes a pair of side walls facing each other,
the bottom rib is shaped to extend in an opposite direction in which the pair of side walls face each other,
the side rib extends along a portion of each of the pair of side walls, the portion intersecting a plane including the bottom rib, and
the side rib includes an outer surface shaped to extend gradually outward in the opposite direction toward the bottom wall.

2. The power storage device according to claim 1, wherein the lower case further includes
a flange projecting outward from an upper end of each of the pair of side walls, and
a thick portion provided on the flange and having a thickness greater than a thickness of the flange.

3. The power storage device according to claim 2, wherein the thick portion is formed at a position distant from the side rib.

4. The power storage device according to claim 1, wherein
the bottom wall includes
a support surface supporting the plurality of power storage cells, and
a recess recessed downward from the support surface, the bottom rib includes
a support surface overlap portion overlapping the support surface in a vertical direction, and
a recess overlap portion overlapping the recess in the vertical direction, and
a length of the recess overlap portion in the vertical direction is smaller than a length of the support surface overlap portion in the vertical direction, and a length of the recess overlap portion in an orthogonal direction is greater than a length of the support surface overlap portion in the orthogonal direction, the orthogonal direction being orthogonal to both the vertical direction and the opposite direction.

5. The power storage device according to claim 4, wherein a lower surface of the support surface overlap portion is flush with a lower surface of the recess overlap portion.

6. The power storage device according to claim 1, wherein the side rib is connected to the bottom rib.

7. The power storage device according to claim 1, wherein the bottom wall, the peripheral wall, the bottom rib, and the side rib are made of a same material and are contiguously connected to each other.

8. The power storage device according to claim 1, wherein the housing is a die-cast case.

9. A lower case that accommodates at least a lower portion of each of a plurality of power storage cells and is open upward, the lower case comprising:
a bottom wall;
a peripheral wall rising from the bottom wall, the peripheral wall inclined gradually outward with an increasing distance from the bottom wall;
a bottom rib provided on the bottom wall; and
a side rib provided on the peripheral wall, wherein
the peripheral wall includes a pair of side walls facing each other,
the bottom rib is shaped to extend in an opposite direction in which the pair of side walls face each other,
the side rib extends along a portion of each of the pair of side walls, the portion intersecting a plane including the bottom rib, and
the side rib includes an outer surface shaped to extend gradually outward in the opposite direction toward the bottom wall.

10. A method of manufacturing the lower case according to claim 9, the method comprising:
a preparation step of preparing a first die and a second die, the first die and the second die being capable of contacting and separating from each other and having a space corresponding to the lower case while being in contact with each other; and
a supply step of supplying a material to the space between the first die and the second die, the material forming the lower case,
wherein in the preparation step,
a die having a side wall forming portion is prepared as the second die, the side wall forming portion forming a portion of each of the pair of side walls other than the side rib, and
a die having a side rib forming portion is prepared as the first die, the side rib forming portion forming the side rib and configured to be in abutting contact with the side wall forming portion, an inner surface of the side rib forming portion corresponding to the outer surface of the side rib.
